(19) United States
(12) Patent Application Publication
(10) Pub. No.: US 2016/0307679 A1
(43) Pub. Date: Oct. 20, 2016

(54) Soft Magnetic Composites for Electric Motors

(71) Applicants: Mitra Lenore TAHERI, Philadelphia, PA (US); Katie Jo SUNDAY, Reinholds, PA (US); Steven Richard SPURGEON, Narberth, PA (US); Steven Joseph MAY, Philadelphia, PA (US)

(72) Inventors: Mitra Lenore Taheri, Philadelphia, PA (US); Katie Jo Sunday, Reinholds, PA (US); Steven Richard Spurgeon, Narberth, PA (US); Steven Joseph May, Philadelphia, PA (US)

(73) Assignee: Drexel University, Philadelphia, PA (US)

(21) Appl. No.: 15/101,056

(22) PCT Filed: Dec. 22, 2014
(86) PCT No.: PCT/US2014/071911

§ 371 Date: Jun. 2, 2016

Related U.S. Application Data
(60) Provisional application No. 61/921,030, filed on Dec. 26, 2013.

(51) Int. Cl. H01F 1/33; B22F 9/04; B22F 1/00; B22F 3/24; B22F 1/02; H02K 1/02; B22F 3/02

(52) U.S. Cl. CPC H01F 1/33; H02K 1/02; B22F 9/04; B22F 3/02; B22F 3/24; B22F 1/02; B22F 1/0044; B22F 1/0011; B22F 2009/041; B22F 2009/043; B22F 2003/248; B22F 2301/35; B22F 2302/25; B22F 2302/45; B22F 2304/10; B22F 2304/15; B22F 2998/10

(57) ABSTRACT

A soft magnetic composite comprising an iron or iron alloy ferromagnetic material coated with an oxide material. An interface between the ferromagnetic material and the layer of oxide contains antiphase domain boundaries. Two processes for producing a soft magnetic composite are also provided. One process includes depositing an oxide layer onto an iron or iron alloy ferromagnetic material by molecular beam epitaxy at a partial oxygen pressure of from 1×10⁻⁵ Torr to 1×10⁻⁷ Torr to form a coated composite. The other process includes milling an iron or iron alloy ferromagnetic material powder and an oxide powder by high-energy milling to form a mixture; compacting the mixture and curing in an inert gas atmosphere at a temperature from 500° C. to 1200° C. to form a soft magnetic composite.

This application claims the benefit of U.S. Provisional Application Ser. No. 61/921,030, filed Dec. 26, 2013, the contents of which are incorporated herein by reference.

This invention was made with government support under Grant No. 1031403 awarded by the U.S. National Science Foundation. The government has certain rights in the invention.

### BACKGROUND OF THE INVENTION

1. Field of the Invention

The present invention is directed to the field of soft magnetic composites. In particular, the present invention is directed to a process of manufacturing soft composites that can withstand high temperatures and to soft magnetic composites made by the process.

2. Description of the Related Technology

The automobile industry is developing electric vehicles. A key component for electric vehicles is cost effective and energy-efficient materials that can be used to build electric motors with more efficient transformer induction cores. These energy-efficient materials enable building of smaller electric motors with equivalent or higher output at a lower cost. The transformer induction cores are typically constructed of silicon steel laminations that are insulated from one another with epoxy, and require a number of forming steps for fabrication that results significant waste from the manufacture. In addition, the planar lamination geometry of these induction cores limits their flux-carrying capability to two dimensions, thereby limiting the number of available options for designs of energy-efficient transformer induction cores.

There is a strong demand for alternative materials that can offer high formability, good magnetic properties, and resistance to eddy current losses that lead to increased power consumption. Soft magnetic composites (SMCs) are a class of materials that exhibit large magnetic permeability and saturation magnetization combined with high electrical resistivity. SMC's are used for electromagnetic cores in many household appliances including kitchen appliances, computers, cellular phones, and televisions. Such components are normally manufactured by conventional powder metal compaction processes often combined with other techniques, such as two step compaction, warm compaction, multi-step compaction and magnetic annealing followed by a heat treatment at a relatively low temperature.

Some SMC's have a metal core coated with a metal oxide layer. Various methods have been developed for providing metal oxide layers onto metals for different applications. These methods may involve, for example, deposition of a metal oxide layer onto a metal, epitaxial growth of a metal oxide layer on a metal and/or oxidation of a surface of the metal to form a metal oxide layer.

U.S. Pat. No. 6,214,712 discloses a process for growing a metal oxide thin film on a metal layer provided on a semiconductor surface using physical vapor deposition in a high-vacuum environment. The process involves the steps of heating the semiconductor surface and introducing hydrogen gas into the high-vacuum environment to develop conditions at the semiconductor surface which are favorable for depositing the metal layer on the semiconductor surface and unfavorable for the formation of native oxides on the semiconductor surface. Subsequently, atoms of metal oxide are directed toward the coated surface of the semiconductor by physical vapor deposition so that the atoms come to rest upon the metal coated semiconductor surface as a thin film of metal oxide.

U.S. Pat. No. 6,524,651 discloses a method for growing a crystalline metal oxide structure. The method comprises the steps of providing a substrate with a clean surface and depositing a metal on the substrate surface at high temperature under vacuum to form a metal-substrate compound layer on the surface with a thickness of less than one monolayer. The compound layer is then oxidized by exposing the compound layer to oxygen at a low partial pressure and low temperature. The method may further comprise the step of annealing the surface while under vacuum to further stabilize the oxidized film structure. A crystalline metal oxide structure may then be epitaxially grown by using the oxidized film structure as an interfacial template and depositing at least one layer of a crystalline metal oxide on the interfacial template.

U.S. Pat. No. 5,482,003 discloses a process that uses molecular beam epitaxy and/or electron beam evaporation to grow a layer of epitaxial alkaline earth oxide film on a substrate in an ultra-high vacuum. A metal is first deposited on the substrate from a flux source until a fraction of a monolayer of the metal covers the substrate surface. See col. 2, lines 25-28. The metal then reacts with oxygen to form a metal oxide that has a lattice parameter similar to that of the lattice structure which provides the material surface. A film of epitaxial layers of the metal oxide is then grown with the selected metal and within the facility so that the lattice parameter of the layers of grown oxide closely approximate the lattice structure of the material surface to reduce the likelihood of lattice strain at the interfaces of the material surface and the epitaxial layers of the alkaline earth oxide built thereon.

U.S. Pat. No. 7,686,894 discloses a method for manufacturing a magnetically soft powder composite material including the following steps: a) preparation of a starting mixture including a pure iron powder, a phosphatized iron powder, or an iron alloy powder and a soft ferrite powder, b) mixing the starting mixture, c) compacting the starting mixture in a press under increased pressure, d) debinding the compacted starting mixture in an inert gas atmosphere or in an oxygen-containing gas atmosphere, and e) heat treating the compacted starting mixture in an oxidizing gas atmosphere at a temperature of 410° C. to 500° C.

2005/0019558 discloses a method for manufacturing a composite of ferromagnetic particles with a magnetite coating. The method comprises coating ferromagnetic particles with magnetite and compacting the particles to a desired shape. The ferromagnetic particles comprise iron or iron alloys. The ferromagnetic particles are coated with iron oxide in the magnetite form (Fe₃O₄). The magnetite coating may be formed by conversion of iron in the iron particles to iron oxide. The coated ferromagnetic particles may optionally be coated with an additional coating comprising a metal oxide, a polymeric resin or a combination of the two.

An important issue with traditional SMCs lies in their electrically insulating coating. These insulating coatings typically cannot withstand post-compaction heating, which results in degraded magnetic and electrical properties of the SMC, limiting its use in electromagnetic devices. The present invention provides improved soft magnetic composite materials with a material layer that is mechanically durable and electrically insulating and which can withstand higher temperatures. The present invention also provides processes for producing the improved soft magnetic composites.

The present invention has numerous applications, not limited to soft magnetic composites. A solid oxide fuel cell (SOFC) is one example of how metallic powders can be coated and used as performance material. Electric connections between metallic powders are necessary for SOFCs, to separate the anode from the cathode. Additionally, coatings are used for connections between cells and for oxidation protection of powders. Coating iron-alloy powders with electrical conductive particles via high-energy ball milling and the process described in this invention, is a viable method for SOFC applications. Applications ranging from the automobile industry to implantable medical devices are feasible with the present invention.

### SUMMARY OF THE INVENTION

In one aspect, the present invention provides a soft magnetic composite comprising a ferromagnetic material selected from iron and iron alloys; and an oxide, wherein the ferromagnetic material is covered by a layer comprising the oxide, and an interface between the ferromagnetic material and the layer comprising the oxide contains antiphase domain boundaries.

In another aspect, the present invention provides a process for producing ferromagnetic particles including the steps of depositing an oxide layer onto a ferromagnetic core comprising a material selected from iron and iron alloys by molecular beam epitaxy at a partial oxygen pressure of from about 1×10⁻⁵ Torr to about 1×10⁻⁷ Torr.

In yet another aspect, the present invention provides a soft magnetic composite produced by compacting a plurality of ferromagnetic particles made by the above process.

In yet another aspect, the present invention provides a process for producing a soft magnetic composite including the steps of milling a ferromagnetic material powder and an oxide powder to form a milled mixture; compacting the milled mixture to form a compact; and annealing the compact at a temperature of from about 400° C. to about 1200° C. to form a soft magnetic composite, wherein the ferromagnetic material powder comprises a material selected from iron powder and iron alloy powders.

In yet another aspect, the present invention provides a soft magnetic composite produced by the above process.

### BRIEF DESCRIPTION OF THE DRAWINGS

FIG. 1 is a flow chart depicting a process for producing a soft magnetic composite using molecular beam epitaxy according to one embodiment of the present invention.

FIG. 2 is a flow chart depicting an alternative process for producing a soft magnetic composite according to an embodiment of the present invention.

FIG. 3 is a schematic representation of an embodiment of the process of FIG. 2, where a mixture of iron powder (large particles, L) and magnetite particles (small particles, S) is ball milled, followed by compacting and annealing (sintering).

FIG. 4A depicts θ-2θ x-ray diffraction patterns of different films produced by the method of Example 1.

FIG. 4B depicts an enlarged view of the region between 2.5-3.3 Å⁻¹ of the x-ray diffraction pattern of FIG. 4A.

FIG. 5A is a bright field cross-sectional transmission electron microscope (TEM) image of a 20 nm Fe film produced by the process of Example 1.

FIG. 5B is a bright field cross-sectional TEM image of a 22.5 nm Fe film produced by the process of Example 1.

FIG. 5C is a bright field cross-sectional TEM image of a 25 nm Fe film produced by the process of Example 1, with the inset showing the high quality of the Fe₃O₄-MgO interface in the film.

FIG. 6A shows in-plane magnetic hysteresis loops of the films produced by the process of Example 1, as measured by a vibrating sample magnetometer (VSM) at 300° K.

FIG. 6B shows in-plane magnetic hysteresis loops of different films produced by the process of Example 1, as measured by a Magneto-Optical Kerr Effect Magnetometer (MOKE) at 300° K.

FIG. 6C shows estimated coercivity (C) as a function of Fe layer thickness measured by each technique for the different films produced in Example 1.

FIG. 7A shows a scanning electron microscope (SEM) image of a coarse, unmilled iron powder particle.

FIG. 7B shows an SEM image of iron powder milled for 4 hours in a hardened steel vial with 2 mm hardened steel media balls.

FIG. 7C shows an SEM image of iron powder milled for 18 hours in a hardened steel vial with 2 mm hardened steel media balls.

FIG. 7D shows an SEM image of iron powder milled for 4 hours in a hardened steel vial with 2 mm hardened steel media balls, then coated with magnetite bulk particles for 1 hour by milling in hardened steel.

FIG. 7E shows an SEM image of iron powder milled for 4 hours in a hardened steel vial with 2 mm hardened steel media balls, then coated with magnetite nanoparticles for 1 hour by milling in hardened steel.

FIG. 7F shows EDS scans of an SEM image of a powder compact, from powder milled for 4 hours in an alumina vial with 2 mm alumina media balls and compacted then cured at 500° C.

FIG. 8A shows x-ray diffraction (XRD) scans for powders milled in an alumina vial with 2 mm alumina media for various amounts of time ranging from 0 hours to 24 hours.

FIG. 8B shows XRD scans for powders milled in an alumina vial for 4 hours with various alumina media ball sizes ranging from 0.5 mm to 3 mm.

FIG. 8C shows vibrating sample magnetometry (VSM) results for powders milled in an alumina vial with 2 mm alumina media balls for various amounts of time ranging from 2 hours to 24 hours, then compacted and cured at 500° C. (black) or 900° C. (red), wherein the inset image shows hysteresis loops obtained by VSM for powders milled for 2 hours (red), 4 hours (blue), and 24 hours (black).

FIG. 8D shows an SEM image for iron powder milled in an alumina vial for 2 hours with 2 mm alumina media balls.

FIG. 8E shows an SEM image for iron powder milled in an alumina vial for 8 hours with 2 mm alumina media balls.

FIG. 8F shows an SEM image for iron powder milled in an alumina vial for 24 hours with 2 mm alumina media balls.

FIG. 8G shows an SEM image for iron powder milled in an alumina vial with 1 mm alumina media balls for 4 hours.

FIG. 8H shows an SEM image for iron powder milled in an alumina vial with 3 mm alumina media balls for 4 hours.

FIG. 8I shows an SEM image of a contact point of four individual powders in a compact from powder milled for 4 hours with 2 mm alumina media balls in an alumina vial, compacted then cured at 500° C.

FIG. 8J shows an EDS scan of FIG. 8I, representing the iron content.

FIG. 8K shows an EDS scan of FIG. 8I, representing the oxygen content.

FIG. 8L shows an EDS scan of FIG. 8I, representing the aluminum content.

FIG. 9A show an SEM image of powder milled with 2 mm hardened steel balls for 2 hours in a hardened steel vial, then milled for 1 hour with bulk Fe₃O₄ particles, then compacted and cured at 500° C.

FIG. 9B shows SEM and EDS images of the powder from FIG. 9A, compacted and cured for 1 hour at 500° C. (top row of images) or 900° C. (bottom row).

### DETAILED DESCRIPTION OF THE PREFERRED EMBODIMENT(S)

For illustrative purposes, the principles of the present disclosure are described by referencing various exemplary embodiments. Although certain embodiments are specifically described herein, one of ordinary skill in the art will readily recognize that the same principles are equally applicable to, and can be employed in other systems and methods. Before explaining the disclosed embodiments of the present disclosure in detail, it is to be understood that the disclosure is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

As used herein, “soft magnetic composite” is a material composed of surface-insulated ferromagnetic powder particles with three-dimensional magnetic flux capabilities. The term “soft” indicates that the magnetic composite possesses a high permeability may be easily magnetized or demagnetized.

In one aspect, the present invention provides a soft magnetic composite comprising a ferromagnetic material insulated with an electrically insulating material containing at least one oxide. The soft magnetic composite of the present invention has an electrical resistivity and magnetic flux density suitable for use in electric motors. Higher resistivity results in lower eddy current losses in alternating magnetic field applications, which reduces energy waste. Second, high magnetic flux density allows development of a strong magnetic field, which enables maximizing the force that can be applied in an electromechanical part.

The ferromagnetic material may be iron or iron alloys such as iron-silicon (Fe-Si), iron-aluminum (Fe-Al), iron-silicon-aluminum (Fe-Si-Al), iron-nickel (Fe-Ni), iron-cobalt (Fe-Co), iron-cobalt-nickel (Fe-Co-Ni), iron-chromium (Fe-Cr), stainless steel (Fe-Cr-Ni) or combinations thereof. In some embodiments, the iron alloys are low carbon steel comprising carbon and manganese, typically less than 0.2 weight percent (wt %) carbon (C) and less than 1 wt % manganese (Mn); Fe-Si alloys may contain less than 3.5 wt % silicon (Si). Fe-Al alloys may contain less than 10 wt % Al. Fe-Co alloys may have a composition comprising about 49 wt % Fe, 49 wt % Co and 2 wt % vanadium (V). Fe-Ni alloys may comprise about 55 wt % Fe and 45 wt % Ni. Fe-Cr alloys may contain less than 20 wt % Cr. Stainless steel alloys may have a composition comprising of less than 20 wt % Cr, 15 wt % Ni, with the balance being mostly Fe. A suitable ferromagnetic material is high purity iron (100 wt % Fe).

The oxide used as the electrically insulating material may be any oxide with high electrical resistivity and/or good room temperature magnetic properties. Examples of suitable oxides include MgO, Fe₃O₄, NiFe₂O₄, CuFe₂O₄, CoFe₂O₄, MnₓZn₁₋ₓFe₂O₄, NiₓZn₁₋ₓFe₂O₄, CoₓZn₁₋ₓFe₂O₄, Cr₂O₃, or Al₂O₃ for “x” values ranging from 0 to 1. The electrically insulating material may be a thin, continuous layer on the ferromagnetic material core. In some embodiments, when the ferromagnetic material is in the form of particles, the electrically insulating material covers the ferromagnetic material particles such that the electrically insulating material separates and insulates the ferromagnetic material particles from each other. The thickness of the electrically insulating material layer may be from 10 nm to 500 nm, or from 10 nm to 300 nm, or from 10 nm to 100 nm.

The soft magnetic composite of the present invention may be characterized by certain structural features. The ferromagnetic material-oxide interface may have a significant number of dislocations. This type of interface boundary is a crystallographic defect in which regions of the atomic structure are ordered in opposite directions referred to as an “antiphase domain boundary” (see Kasama, T., et al. “Off-axis electron holography observation of magnetic microstructure a in a magnetite (001) thin film containing antiphase domains,” Physical Review B. vol. 73, page 104432 (2006); and D. T. Margulies, et al. Physical Review B. vol. 53, page 9175 (1996), all of which are hereby incorporated by reference in their entirety).

The density of the antiphase domain boundaries may depend on film geometry. Gilks et al., “Magnetism and magnetotransport in symmetry matched spinels: Fe3O4/MgAl2O4,” J. Applied Physics, vol. 113, pages 17B107 (2013) found that the formation of antiphase domain boundaries in Fe₃O₄ film does not depend on dislocation densities, but instead results from three-dimensional film growth. Moreover, Moussy et al., “Thickness dependence of anomalous magnetic behavior in epitaxial thin films: Effect of density of antiphase boundaries ,” Phys. Rev. B, vol. 70, pages 174448 (2004) have shown an inverse dependence of APB density on film thickness, suggesting that this is tunable.

The antiphase domain boundary has a significant effect on the magnetic behavior of the soft magnetic composite of the present invention. For example, the antiphase domain boundary may provide an increase in magnetization at the interface of the ferromagnetic and oxide layers.

In some embodiments, the surface of the ferromagnetic material may have a thin layer of Fe₂O₃, which may be formed by exposing the ferromagnetic material to oxygen in order to oxidize the iron on the surface of the ferromagnetic material to Fe₂O₃. In one embodiment, this Fe₂O₃ layer has a thickness of about 2-3 nm. This layer imposes an exchange bias on the underlying layer as well as a decrease in saturation magnetization, as a function of the thickness of the layer. Additionally there exists a transition from predominately Néel to Bloch domain wall types that results in a transition from increasing to decreasing coercivity at the interface with the Fe₂O₃ layer.

Without being bound by theory, it is thought that exchange bias arises from an interfacial exchange interaction between uncompensated spins in an antiferromagnetic (AF) layer and free spins in an adjacent ferromagnetic (FM) layer. This exchange interaction pins the spins of the FM, imposing an additional exchange field (or bias) on it. Because Fe₂O₃ is a weak AF, it exerts a significantly large bias on the FM layer. When the surface Fe₂O₃ layer is thin, uncompensated spins are able to rotate with the adjacent FM spins due to weak AF coupling. As the thickness of the AF layer increases, the coupling strength increases. Eventually a point is reached where the AF layer imposes a significant bias on the FM layer.

The Fe₂O₃ layer may also result in significant differences in the shape of the measured magnetic hysteresis loops of the soft magnetic composite. The combined Fe₂O₃ layer and ferromagnetic material possess a significant in-plane uniaxial anisotropy imposed by the exchange bias, and thus has a harder, further shifted loop. The presence of the Fe₂O₃ layer may also provide a discernible increase in the coercivity of the soft magnetic composites. Particularly, the coercivity increases as a function of the thickness of the Fe₂O₃ layer. The presence of the Fe₂O₃ layer may also decrease the saturation magnetization of the soft magnetic composite.

In summary, the microstructure of the soft magnetic composite, especially the ferromagnetic material-oxide material interlayer boundaries and optional Fe₂O₃ layer, may play a significant role in mediating saturation magnetization and coercivity.

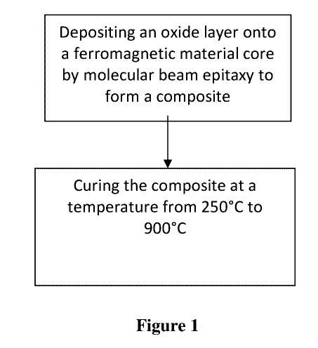

In another aspect, the present invention provides a method for manufacturing the soft magnetic composite (FIG. 1). This method comprises the steps of: depositing an oxide onto a ferromagnetic material core by molecular beam epitaxy to form an oxide layer thereon and annealing. Deposition of the oxide layer by molecular beam epitaxy may be carried out at an oxygen partial pressure pO₂ of from about 1×10⁻⁵ Torr to about 1×10⁻⁷ Torr, or from about 5×10⁻⁶ Torr to about 5×10⁻⁷ Torr, or from about 3×10⁻⁶ Torr to about 8×10⁻⁷ Torr. In some embodiments, the partial oxygen pressure during the deposition step is maintained using a combination of O₃/O₂ as an oxidizing agent. The ratio of O₃/O₂ in the combination may be from about 99:1 to about 1:1, or from about 95:5 to about 75:25, or from about 92:8 to about 85:15. In a preferred embodiment, the combination has about 90% O₃ and 10% O₂.

Molecular beam epitaxy (MBE) is a well-known process where molecular deposition is conducted in an ultra-high vacuum growth chamber. In typical molecular beam epitaxy equipment, a substrate material is positioned in the chamber for receiving the molecular deposition. The substrate may be, for example, MgO. The substrate may be subjected to direct heating to maintain the substrate at a desirable temperature in a range of from 250° C. to 600° C. during deposition. In addition, the ultra-high vacuum growth chamber is evacuated to a pressure of below ˜10⁻⁶ Pa, or below ˜5×10⁻⁷ Pa, or below ˜10⁻⁸ Pa, or below 10⁻⁹ Pa, to ensure that no stray molecules adsorb onto the surface. A plurality of canisters are provided for providing a vapor source of metal desired to be deposited on the material's receiving surface during the molecular deposition process. Each canister may hold a different metal and contains heating elements for vaporizing the metal. An opening is provided for each canister, and a shutter is associated with the canister with movement between a closed position at which the interior of the canister is closed and thereby isolated from the growth chamber and an open position at which the contents of the canister, i.e., the metal vapor, is released to the growth chamber. In addition, an oxygen source is connected to the growth chamber so that by opening and closing a valve associated with the oxygen source, oxygen can be delivered to or shut off from the chamber. The opening and closing of each canister shutter and the oxygen source valve may be accurately controlled by a computer.

If two or more metals are employed in the MBE process, the ratio of the metals may be controlled by the amount of each metal provided to the growth chamber to allow precise compositions to be deposited on the receiving material (ferromagnetic material). The presence of oxygen in the growth chamber will oxidize the metal and thus form an oxide to be deposited on the ferromagnetic material core. A skilled person will appreciate that desired oxide(s) may be formed in the growth chamber by controlling the amount of metal(s) and oxygen supplied to the growth chamber.

In some embodiments, the formation of a crystal structure as the oxide is being deposited on the ferromagnetic material may be monitored by reflection high energy electron diffraction (RHEED). This allows for evaluation of crystalline layers in order to determine if undesirable, amorphous oxide layers are produced. The thickness of the oxide layer may be from 10 nm to 500 nm, or from 10 nm to 300 nm, or from 10 nm to 100 nm.

In some embodiments, at least a portion of the ferromagnetic material is also deposited on the ferromagnetic material core. This ferromagnetic material may be the same or a different ferromagnetic material than the material of the core.

Referring to FIG. 1, after deposition of the oxide layer on the ferromagnetic material core, an annealing step may be carried out to ensure full oxidation. The annealing of the soft magnetic composite is typically performed in a tray oven, or a high temperature furnace. In some embodiments, the annealing is carried out in an inert atmosphere such as a nitrogen, argon, or argon and hydrogen combination atmosphere. In some other embodiments, the annealing is performed in a reactive atmosphere such as air. In general, the annealing is performed at a thermal treatment temperature of about 250° C. to about 1200° C., or from about 300° C. to about 1000° C., or from about 400° C. to about 900° C., or from about 500° C. to about 800° C. The time period for the annealing may be from about 15 minutes to about 4 hours, or from about 30 minutes to about 3 hours, or from about 45 minutes to about 2 hours. In some embodiments, the time period for annealing is for about 60 minutes.

The molecular beam epitaxy method allows epitaxial growth of single crystals on the ferromagnetic material. This method provides very accurate compositional control and ensures crystalline purity. The ability to introduce multiple elements into the ultra-high vacuum growth chamber of the molecular beam epitaxy at the same time is beneficial. Since the shutters to each elemental-containing canister may be controlled via a computer, multiple shutters can be opened at the same time, allowing for complex oxides to be deposited, with precise control of the composition and thickness of the oxide layer. For example, to deposit nickel ferrite (NiFe₂O₄), iron and nickel atoms are released into the growth chamber in the presence of oxygen. The amount of metals released may also be used to control the oxide deposition rate.

Another advantage of molecular beam epitaxy is that beams of evaporated atoms may be directed up the growth chamber toward the receiving surface, thus preventing the elemental atoms from interacting with one another until they reach the receiving surface. This is because of the long mean free path of the atoms, achieved under sufficient pressure (for example, below 10⁻⁵ Torr).

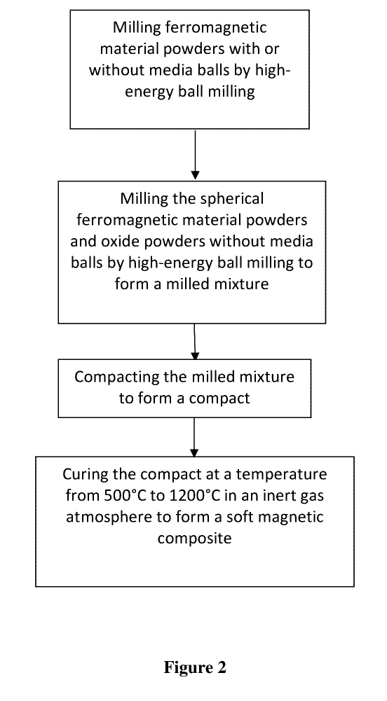

In yet another aspect, the present invention provides a plastic deformation based method for manufacturing the soft magnetic composite from a ferromagnetic material and an oxide (FIG. 2). This method comprises the steps of milling a ferromagnetic material powder and an oxide powder to form a mixture, compacting the milled mixture to form a compact; and annealing the compact at a temperature of from about 500° C. to about 1200° C. to form a soft magnetic composite.

Any apparatus suitable for grinding or mixing particles by inducing severe plastic deformation such as high energy ball mills may be used for the milling step. In an exemplary embodiment, the milling step may be performed by a high-energy ball mill SPEX Sample Prep 8000D Mixer/Mill. High energy ball milling has been describe previously in Le Caër, “High-Energy Ball-Milling of Alloys and Compounds,” Hyperfine Interactions, vol. 141-142, pages 63-72, (2002), which is incorporated herein by reference in its entirety.

The particle size of the ferromagnetic material powders may be from about 10 μm to about 1000 μm, or from about 30 μm to about 700 μm, or from about 50 μm to about 600 μm, or from about 100 μm to about 500 μm, or from about 250 μm to about 400 μm. In some embodiments, the ferromagnetic material powders may have multiple sizes of particles.

The particle size for the oxide powders may be from about 10 nm to about 50 μm, or from about 50 nm to about 20 μm, or from about 50 nm to about 10 μm, or from about 1 μm to 5 μm or from about 50 nm to about 100 nm. In some embodiments, the oxide powders may include a combination of at least two types of particles, for example, a combination of particles of 1 μm to 5 μm and nanoparticles of 50 nm to 100 nm.

In some embodiments, the particle size difference between the ferromagnetic powder and oxide powder should be sufficiently large to ensure adequate coating of the oxide particles onto the ferromagnetic material particles and for maximum magnetization and minimum coercivity results. In some embodiments, the particle size ratio between the ferromagnetic material powder and oxide powder is about 5 to about 40,000, or from about 10 to about 15,000, or from about 50 to about 1,5000, or from about 100 to about 1000.

High-energy milling is one way to mechanically mill the particles in of the ferromagnetic and oxide powder mixtures. The milling produces large amounts of strain in the powder by grinding away rigid edges to form a more uniform surface area while maintaining the overall size. In one aspect, the mechanical milling step results in severe plastic deformation of the particles to change the shape of the particles, preferably into substantially spherical or spherical particles. The mechanical milling step also renders the surface area of the ferromagnetic particles substantially uniform or uniform. The mechanical milling step also reduces the porosity of the ferromagnetic particles, by decreasing internal air gaps with sufficient amount of deformation or mill time. Small grinding media, in the range of 0.5 mm to 3 mm, is preferred over large grinding media of >5 mm in order to increase the number of contact points between the powder and media balls. Mechanical milling allows for the porosity to be reduced or minimized, depending on the length of time and ratio of powders to grinding media used. The process may achieve high coverage of the ferromagnetic powder with the oxide particles, with coverage greater than 90%, or greater than 95%, or at about 100%. High-energy ball milling is one example of a method for carrying out mechanical milling. Equal channel angular pressing (ECAP) and high pressure torsion (HPT) mechanical milling techniques also allow for severe plastic deformation of particles to change their shape by compacting the particles under high pressure.

A skilled technician may determine the mill time by monitoring the formation and coating of the oxide material layer with techniques such as TEM or SEM. One way to determine an appropriate milling time is to optimize milling for formation of a single oxide particle layer on the ferromagnetic particles in combination with achieving a high coverage of the ferromagnetic particle of at least 90% or greater. In some embodiments, the milling time is from about 1 to about 5 hours, or from about 1.5 to about 4 hours, or from about 2 to about 3 hours.

In other embodiments, polymeric resins may be added to the milling step. The polymeric resin may be selected from a wide variety of thermoplastic resins, thermosetting resins, and blends of thermoplastic resins, or blends of thermoplastic resins with thermosetting resins. The polymeric resin may also be a blend of polymers, copolymers, terpolymers, dendrimers, ionomers or combinations comprising at least one of the foregoing polymeric resins.

Examples of thermoplastic resins include polyacetals, polyacrylics, polycarbonates, polystyrenes, polyolefins, polyurethanes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, and combinations thereof. Examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations thereof.

Examples of polymeric thermosetting materials include polyurethanes, natural rubber, synthetic rubber, epoxy, phenolic, polyesters, polyamides, silicones, and combinations thereof. Blends of thermosetting resins, as well as blends of thermoplastic resins with thermosetting can also be utilized.

The milling step may be conducted in, for example, a hardened steel vial with hardened steel balls as grinding media. Other grinding media and containers such as alumina or zirconia may be employed, and combinations of various media vials with various media balls may be used depending on necessary hardness ratings for deforming powders. For example, alumina grinding balls can be milled with powder in a hardened steel vial, to ensure more deformation, due to alumina being a harder material than steel, when ball-to-powder contact occurs. Though the media materials should be selected to minimize contamination of the composite with the material of the grinding media or container. In some embodiments, the vial and grinding media may be pre-coated with pure iron powder to minimize potential contamination. Pre-coating may be performed by milling the grinding media with pure iron for up to 24 hours until a uniform coating layer on the grinding media vial and balls are formed.

The grinding media may have a diameter of from about 0 1 mm to about 12 mm, or from about 0.5 mm to about 6 mm, or from about 1 mm to about 3 mm. The pre-coating may be conducted for a period of from about 0.5 hour to about 48 hours, or from about 1 to about 24 hours, or from about 4 to about 12 hours, or from about 6 to about 8 hours.

The ferromagnetic material may optionally be annealed prior to the milling step, for the purpose of improving the magnetic properties of the ferromagnetic material and the composites derived therefrom. This step is referred to as pre-milling annealing. The ferromagnetic material powder may be subjected to pre-milling annealing at temperatures of from about 500° C. to about 1200° C., or from 600° C. to 1000° C., or from 700° C. to 900° C. The pre-milling annealing may be carried out for a time period of from about 15 minutes to about 150 minutes, or from 30 minutes to 120 minutes, or from 40 minutes to 100 minutes. In one embodiment, the pre-milling anneal is carried out at a temperature of about 800° C. for a time period of about 60 minutes.

The pre-milling anneal step may be carried out in any protective atmosphere, such as, for example, argon, nitrogen, hydrogen, or a combination thereof, to avoid surface oxidation of ferrous powders. In one embodiment, the pre-milling annealing is a decarburizing annealing process that is performed under a standard decarburizing atmosphere to reduce the carbon content in the particulates to lower levels than are found in the ferromagnetic material particles prior to annealing. Carbon levels may be reduced to as low as 0.0002 wt % depending on the decarburizing process conditions and the carbon level of the starting ferromagnetic material.

In some embodiments, the milling step may comprises two sub-steps: milling the ferromagnetic material particles with the media for a period from about 1 hour to about 24 hours, or from about 2 hours to about 12 hours, or from about 4 hours to about 8 hours to deform the ferromagnetic particles and subsequently milling the deformed ferromagnetic particles with an oxide powder. The first milling step can be employed to severely deform the ferromagnetic material particles into spheres, reduce their porosity or internal air gaps, and increase their surface area uniformity. After removing the media from the ferromagnetic particles, an oxide powder is added and the deformed ferromagnetic material particles are then milled with the oxide powder to coat the ferromagnetic particles. This second milling step may be performed for from about 0.5 hour to about 2.5 hours, or from about 0.75 hour to about 2 hours, or from about 0.75 hour to about 1.5 hours.

In some embodiments, the milling step is a one-step procedure: milling the ferromagnetic particles without media and with an oxide powder for a period of about 1 hour to about 24 hours, or from about 2 hours to about 12 hours, or from about 4 hours to about 8 hours. This minimizes plastic deformation, since there is an absence of media balls, only powder-to-powder and powder-to-vial contacts are made. Irregular shapes are maintained, though the oxide coating is the least uniform and unpredictable.

After the milling steps, the ferromagnetic material particles are at least partially or completely covered with an oxide layer. The oxide layer on the ferromagnetic material particles may be as thin as possible while still being capable of insulating adjacent ferromagnetic particles from each other such that an insulation value of from about 0.5 to about 20 milli-Ohm centimeters, or from about 1 to about 15 milli-Ohm centimeters, or from about 2 to about 12 milli-Ohm centimeters, or from about 4 to about 10 milli-Ohm centimeters is obtained. The thickness of the oxide layer may be from about 10 nm to about 500 nm, or from about 10 nm to about 300 nm, or from about 10 nm to about 100 nm.

High-energy milling such as high-energy ball milling allows for severe plastic deformation of powder mixtures that can create powder mixtures not limited by the starting powder shape. For example, uniform powders are not required as starting materials for high-energy ball milling. This technique avoids the cost of preparing spherical, uniformly shaped powders as may be required by other processes such as gas atomization. In addition, severe plastic deformation reduces or minimizes porosity of the powders, depending on the length of the milling time and the ratio of powders to grinding media that are employed.

Referring to FIG. 2, the compacting step may be conducted using a force from about 80 psi to about 725 ksi, or from about 100 psi to about 435 ksi, or from about 200 psi to about 145 ksi, or from about 500 psi to about 75 ksi, or from about 1 ksi to about 10 ksi. This compacting step may improve bond structure and achieve complex geometries. Suitable compaction techniques include die pressing, uniaxial compaction, isostatic compaction, injection molding, extrusion, and hot isostatic pressing. Hot isostatic pressing can be used to perform compacting and sintering simultaneously in order to both to reduce porosity and increase the density of powder mixtures.

The oxide layer is capable of binding adjacent ferromagnetic particles together with exertion of sufficient force during compacting. Through compacting, transverse rupture strength is imparted to the compact such that acceptable mechanical properties can be achieved via compaction without simultaneous or subsequent sintering. A transverse rupture strength of from about 50 mega Pascals (MPa) to about 130 MPa, or from about 70 MPa to about 110 MPa, or from about 80 MPa to about 100 MPa is desirable, as determined in accordance with the protocol of the American Society of Test Materials (ASTM) MPIF Standard 41.

Referring to FIG. 2, after the compacting step, the formed compact may be cured at a temperature from about 400 to about 1200° C., or from about 600 to about 1000° C., or from about 800 to about 900° C. for relieving stresses. In some embodiments, the curing is carried out in an inert atmosphere such as a nitrogen, argon, or argon and hydrogen combination atmosphere. In other embodiments, the curing is performed in a reactive atmosphere such as air. This curing of the coated ferromagnetic material particles may be carried out for a time period of from about 30 minutes to about 5 hours, or from about 1 hour to about 3 hours.

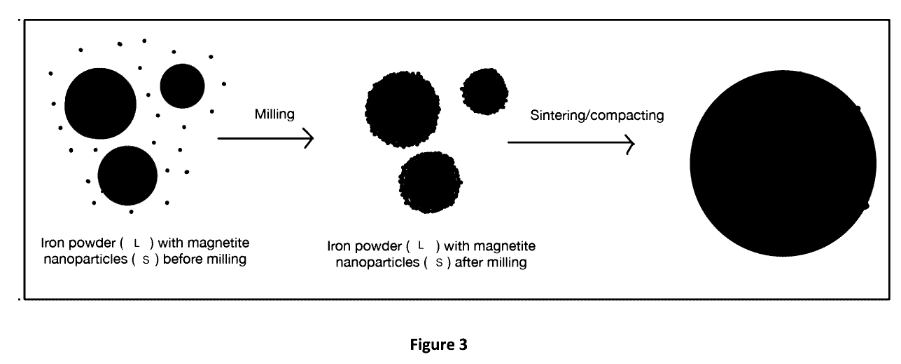

In one embodiment, as shown in FIG. 3, as-received spherical iron powder (large particles) is mixed with magnetite nanoparticles (small particles), which are then milled to form iron powder particles that are at least partially or completely coated with a magnetite layer. The coated iron powder particles are then compacted and cured at a temperature of from about 500 to about 1200° C. This process may also be carried out starting from non-uniform ferromagnetic particles, which have been mechanically milled as discussed above.

The high energy milling process produces soft magnetic composites with low coercivity and high magnetization. The oxide layer may include oxides of metals that are different from the metal(s) in the ferromagnetic material core, which may provide the capability of producing soft magnetic composites with desirable magnetic properties. For example, different applications for the soft magnetic composites, such as jet engines, high-speed rail engines, household fans and DVD players may require different magnetic properties. Variations of iron, nickel, cobalt, silicon, chromium etc. independently in both the ferromagnetic material core and oxide layer allow for customization of the soft magnetic composition by providing different magnetic properties. These compositional differences may be achieved by selection of the starting ferromagnetic material(s) and oxide metals.

Another advantage of the high energy milling process is that more accurate control of the thickness of the oxide layer can be achieved as compared to some other processes. By varying one or more of the milling parameters, the size of the oxide powder particles, as well as the relative amount of the oxide powder employed, the process allows coatings of a desired thickness to be applied to the ferromagnetic material core. Very thin oxide layers can be applied by this process, with the oxide layer still providing the desired degree of insulation. This process can also ensure full coverage of the ferromagnetic material particles with oxide layer for eliminating the possibility of the ferromagnetic material powder welding to itself during compaction or annealing, which could result in an undesirable increase in eddy current losses. Full coverage would also make for a stronger and denser product. Particle collisions during the milling step helps to achieve full coverage by producing spherical ferromagnetic powder particles, which are easier to coat uniformly, have higher magnetization, and reduce porosity in the ferromagnetic material as well as in the oxide layer. The collisions also create bonding at the interface between the ferromagnetic powder particles and the oxide layer, which provides desirable magnetic properties. For example, the bonds formed by ferromagnetic particles and the oxide layer may provide lower coercivity and reduced eddy currents, as well as a softer magnetic composite.

The present invention may employ bulk ferromagnetic powder and nanoparticles of oxide powder. Variation of the particle sizes for both ferromagnetic powder and oxide powder allows for more precise control over the magnetic and electrical properties. The present invention provides soft magnetic composites having a high electrical resistivity and magnetic flux density that enable manufacturing of more efficient electric motors that can tolerate high temperatures.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the scope of the disclosure.

### Example 1

Commercial 1×1 cm² MgO (001) substrates purchased from MTI Corporation were cleaned using acetone and isopropyl alcohol. Nominally, 40 nm Fe₃O₄ layers were deposited on these substrates using molecular beam epitaxy at a pO₂≈2×10⁻⁶ Torr. Iron layers with different thicknesses (20, 22.5, 25, and 30 nm) were then deposited on the substrate without substrate heating. These thicknesses were chosen to coincide with a measured penetration thickness of the SMOKE signal for this system. These iron layers permit pseudo-depth profiling using the SMOKE technique.

### Example 2

The bilayer films formed in Example 1 were studied with X-ray diffraction (XRD). Measurements were taken from 2θ=20 to 80° at room temperature using Cu K_{α} (λ=1.541 Å) radiation at 44 kV and 40 mA. The patterns were normalized to the intensity of the MgO (002) substrate reflection for comparison and analyzed using the Jade software package.

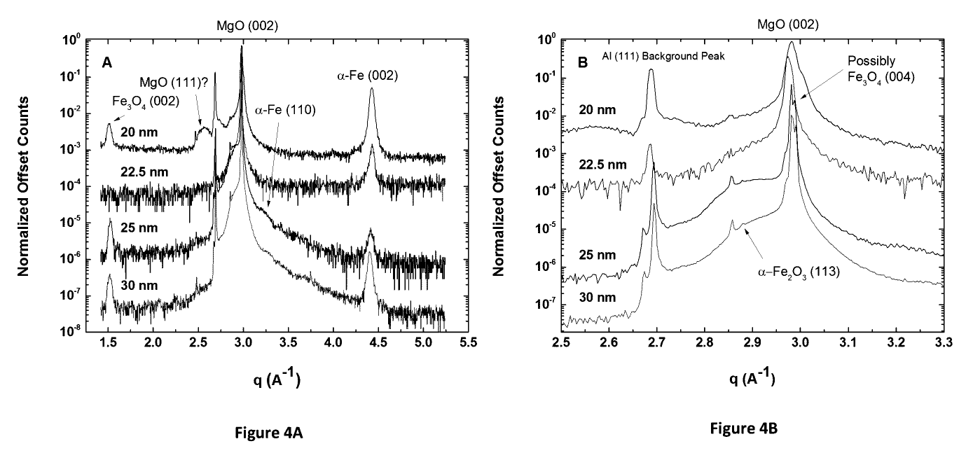

Referring to FIGS. 4A-4B, there was a sharp MgO (002) reflection at q=2.98 Å⁻¹ and an A1 (111) reflection at 2.69 Å⁻¹, likely due to footprint overlap with the aluminum sample stage. A clear α-Fe (002) peak at 4.43 Å⁻¹ and a small α-Fe (110) side peak near 3.27 Å⁻¹ were also identified. The side peak appeared in the thicker iron films. Fe₃O₄ (002) and (222) where peaks were observed at 1.51 and 2.67 Å⁻¹, respectively. The former peak was absent from the 22.5 nm film, while the latter was significantly weakened in both the 22.5 and 20 nm films. This suggests that the interface between Fe₃O₄ layer and iron layer is more disordered in the case of the thicker bilayers. It was also noted that an a-Fe₂O₃ (113) peak near 2.86 Å⁻¹ increased in intensity with increasing iron thickness. This is likely due to increasing oxidation of the iron layer.

### Example 3

The bilayer films formed in Example 1 were studied with transmission electron microscopy (TEM). Cross-sectional TEM samples were prepared using conventional polishing techniques. Small sections were glued to one another using Epotek brand M-Bond epoxy and then cured for several hours at 100° C. These sections were polished to about 10 μm thickness using a low-speed polishing wheel and diamond lapping film. They were then iron milled using a Fischione 1010 Low-Angle iron Mill operating at 0.5-1.5 keV and 10-15° incidence angle. Bright field and diffraction images were taken using a JEOL 2100 LaB₆ TEM operating at 200 keV.

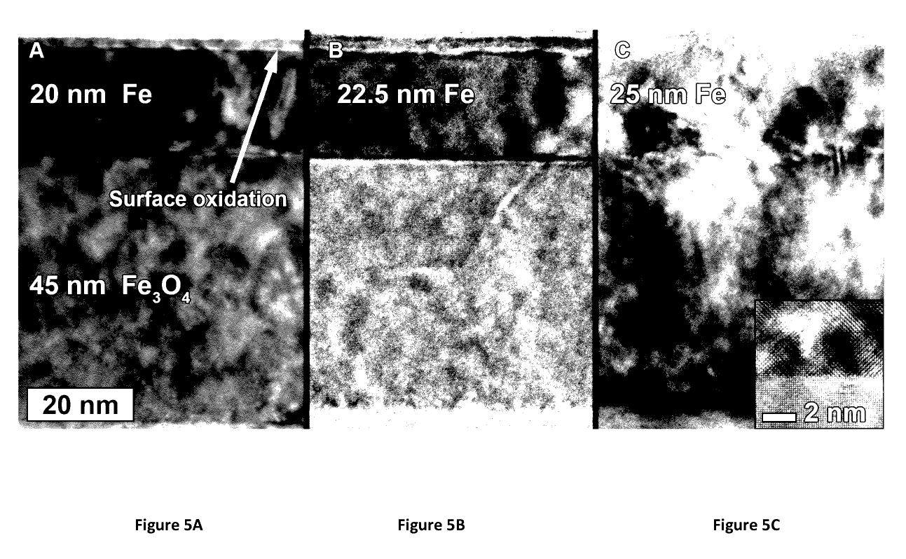

Referring to FIGS. 5A-5C, a series of bright field cross-sectional TEM micrographs depicted microstructures of the films made in Example 1. TEM micrographs showed interlayer boundaries between the Fe₃O₄ layer and iron layer, which are antiphase domain boundaries. The Fe-Fe₃O₄ interface displayed a significant number of dislocations, owing to the disorder of the underlying Fe₃O₄ layer. On the contrary, the Fe₃O₄-MgO interface was quite sharp and dislocation free, as shown in the inset of FIG. 5C. The presence of an about 2-3 nm surface oxide on the top iron layer was seen to increase with increasing iron layer thickness. The surface roughness also increased with increasing iron layer thickness.

### Example 4

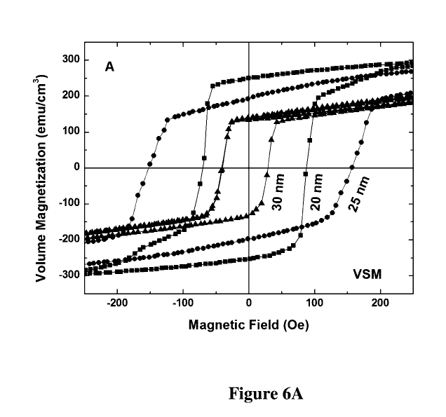

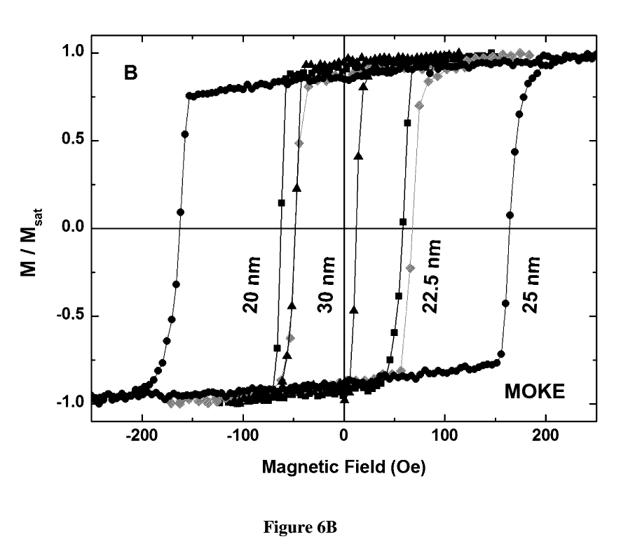

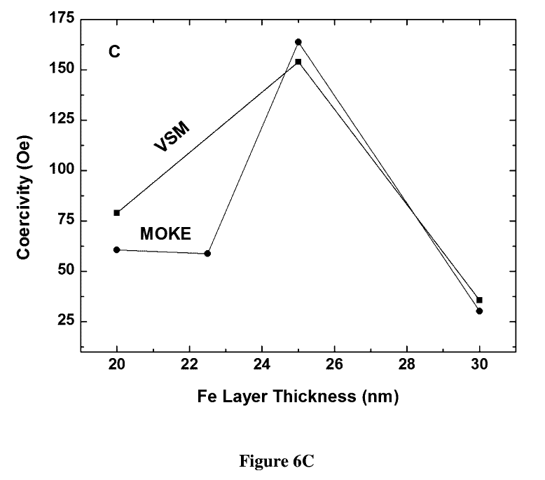

Bulk in-plane magnetic hysteresis of the bilayer films formed in Example 1 was measured using a Quantum Design PPMS Vibrating Sample Magnetometer (VSM) at 300 K along the MgO<100> direction at room temperature, shown in FIG. 6A. Surface magnetization was also measured using a custom-designed SMOKE magnetometer at 300 K along the in-plane MgO<100> direction at room temperature, shown in FIG. 6B. Both measurements indicate that coercivity increases with increasing iron layer thickness, reaching a maximum near 25 nm (FIG. 6C). Moreover, it was observed that the Fe₂O₃ layer imposes an exchange bias on the underlying iron layer, which is reflected in the shape of the SMOKE and VSM hysteresis loops.

### Example 5

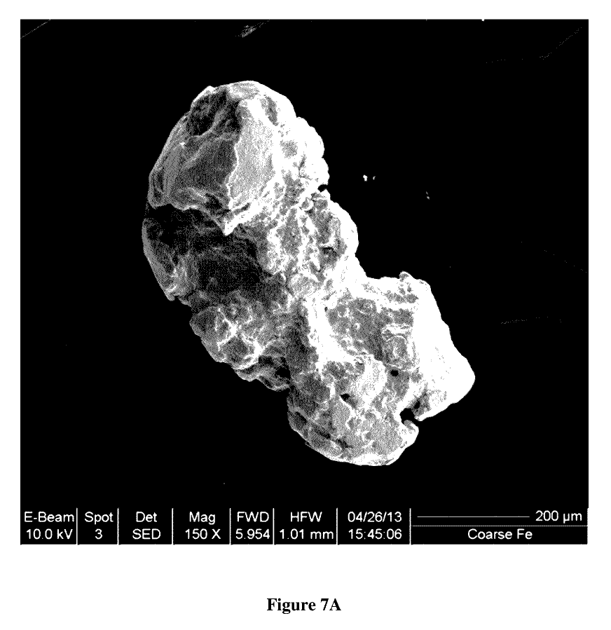

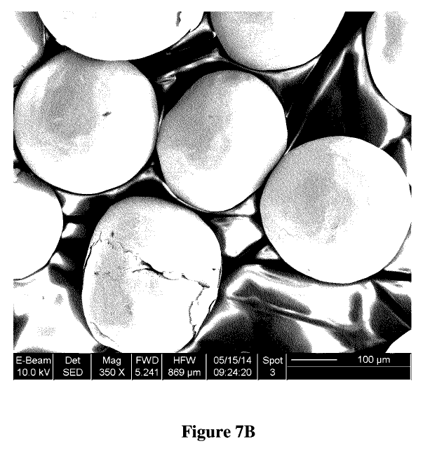

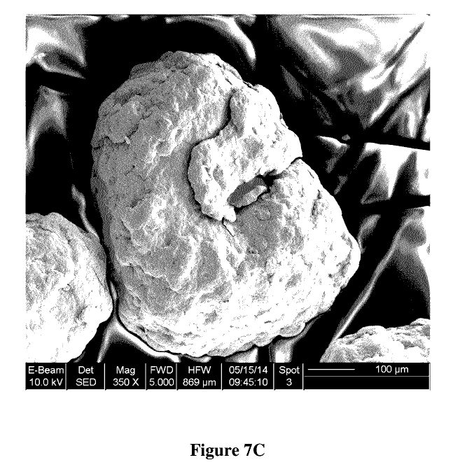

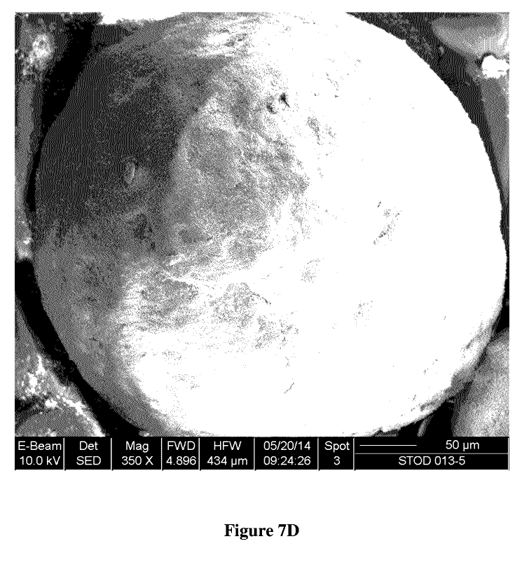

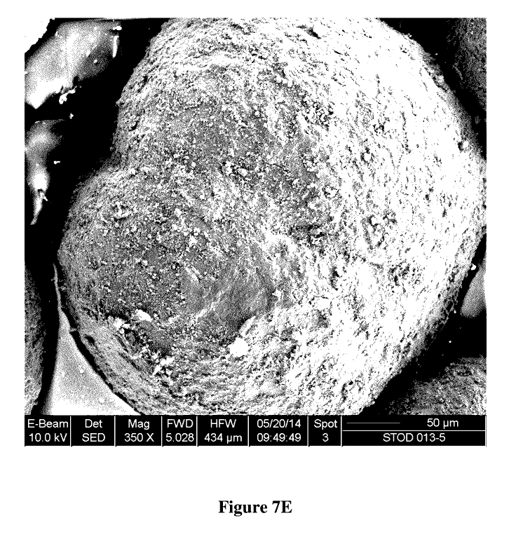

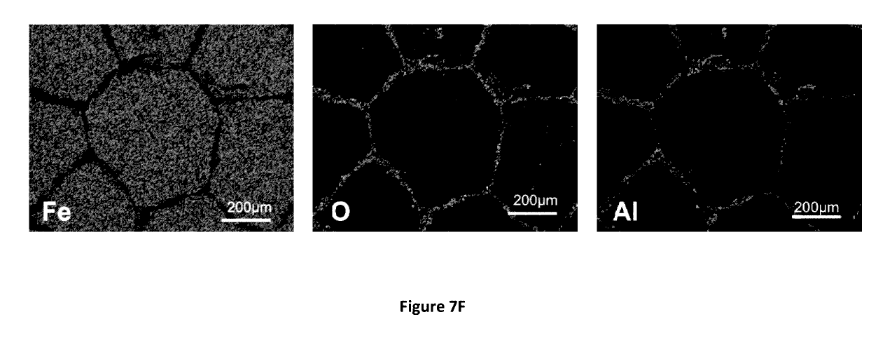

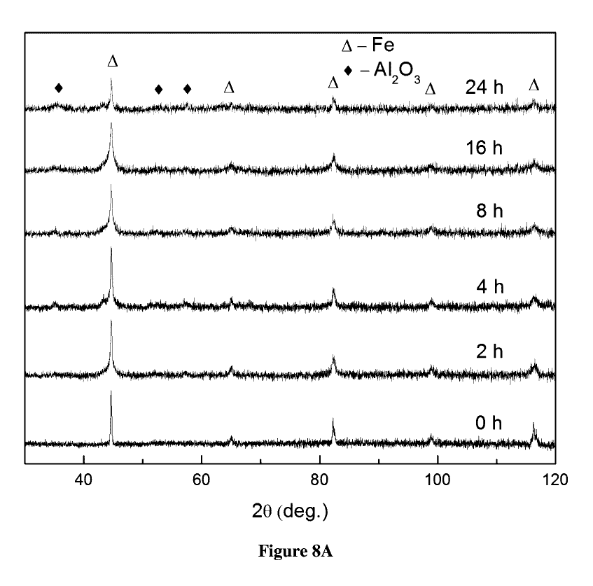

Powder mixtures were prepared in a high-energy ball mill (SPEX 8000). Two types of pure iron powder were used, coarse (diameters of 420 μm to 150 μm) and fine (diameters of 150 μm to 45 μm). FIG. 7A is a SEM image of an iron particle before milling. The iron particle has an irregular shape. Two types of ferrite particles were also used, bulk (diameters of 5 μm to 1 μm) and nanoparticles (diameters of 100 nm to 50 nm). There was no added mixing agent or lubricant such as a polymer carrier, micro wax or stearic acid solution used in the milling step to avoid flammable products for safety reasons and to avoid extensive amounts of processing procedures. Experiments were conducted in air in an alumina ceramic vial with alumina grinding media or in a hardened steel vial with hardened steel media. Each vial and grinding media were pre-coated with pure iron powder. Pre-coating was completed by milling the grinding media with pure iron in the vial for several hours until a uniform layer was achieved. The grinding media was varied and had diameters of 3 mm, 2 mm, 1 mm, and 0 5 mm for the alumina balls and 2 mm for the hardened steel balls, depending on the trial. Milling times were varied from 2 to 24 hours. Longer milling times allowed for smaller, spherical particles with minimal amounts of internal air gaps, and thicker coating layers. The powder mixture was separated from the grinding media using sieves of proper mesh size. Oxide material, either bulk or nano-particles, were then added to the milled powder and milled again for 1 hour.

FIG. 7B shows an SEM image of iron powder milled for 4 hours in a hardened steel vial with 2 mm hardened steel media balls. This image is evidence that powders form spherical shapes after 4 hours of mill time. FIG. 7C shows an SEM image of iron powder milled for 18 hours in a hardened steel vial with 2 mm hardened steel balls. There are extensive amounts of deformation for powders milled for 18 hours, as evidence in the surface morphology.

FIG. 7D shows an SEM image of iron powder, which was milled for four hours then coated with bulk iron oxide particles for 1 hour. FIG. 7E shows an SEM image of an iron powder, which was milled for 4 hours then coated with nanoparticles of iron oxide for 1 hour. Powders coated with nanoparticles have large amounts of agglomerations of these particles on the surface.

Compacts were prepared by compaction with roughly 725 ksi of force in a die press. This compaction technique is extremely advantageous in that complex geometries are possible and any shape of powder is compactable. The compacts underwent subsequent curing in a vacuum furnace under argon and hydrogen atmosphere, for one hour at temperatures ranging from 500° C. to 1000° C. FIG. 7F shows EDS scans of an SEM image of a powder compact from the above example, where powder was milled for 4 hours in alumina with 2 mm alumina media balls and compacted then cured at 500° C. Individual powders are clearly coated with alumina and most likely with the oxide material. The compaction of powders is a severe plastic deformation technique beneficial for improving bond structure and physical shape. Isostatic pressing is an additional option for achieving simultaneous compacting and sintering and to reduce the porosity and increase the density of powder mixtures. Hot Isostatic Press (HIP) may be used for this purpose.

### Example 6

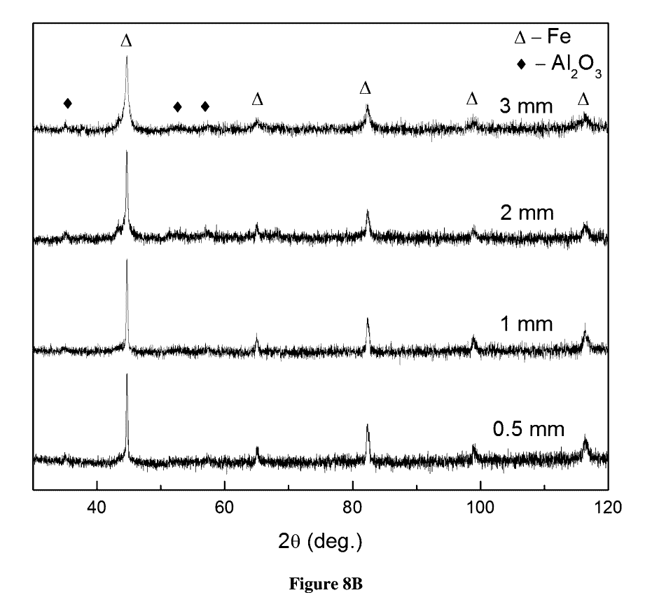

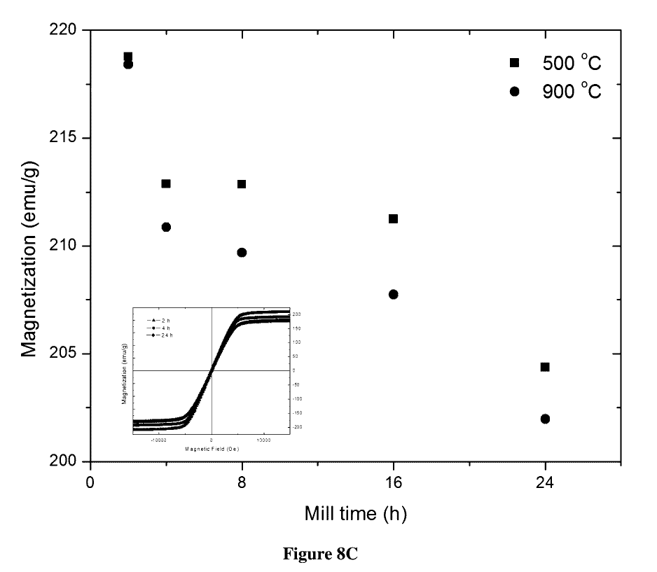

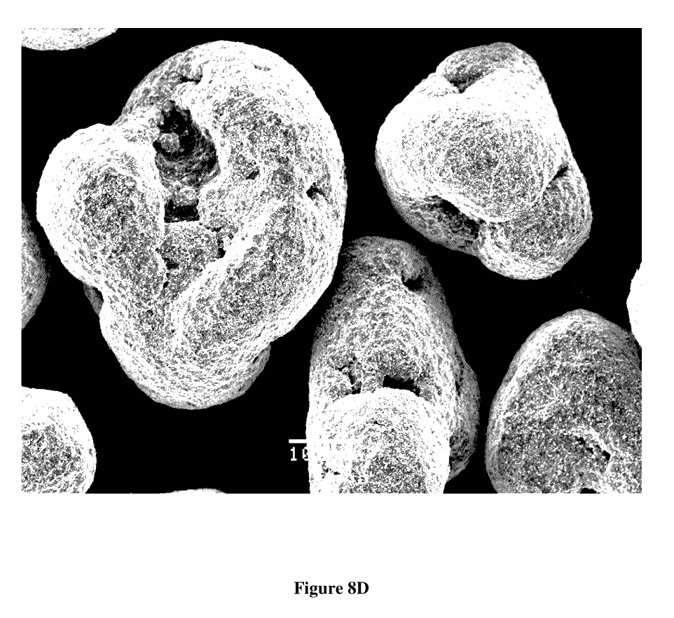

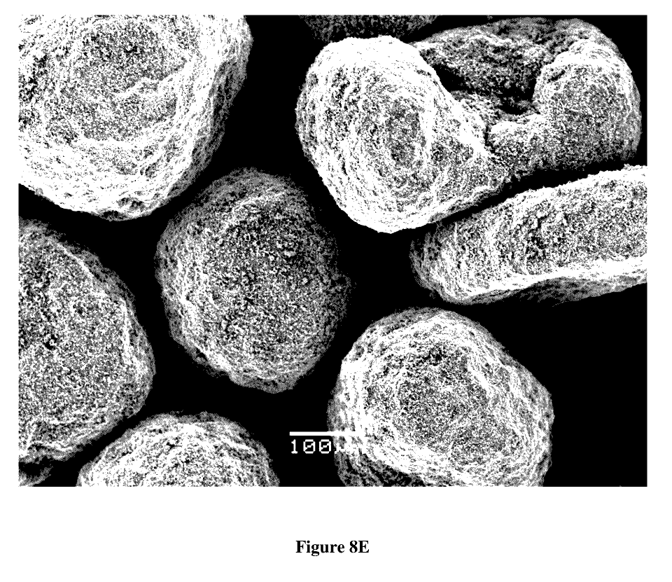

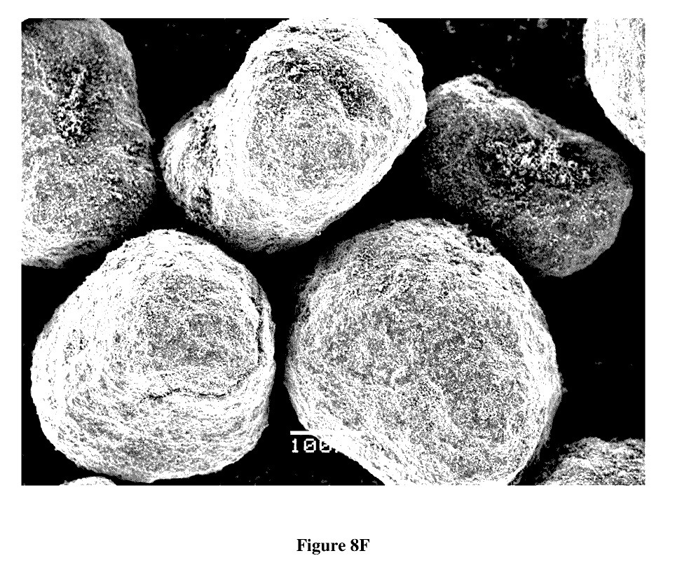

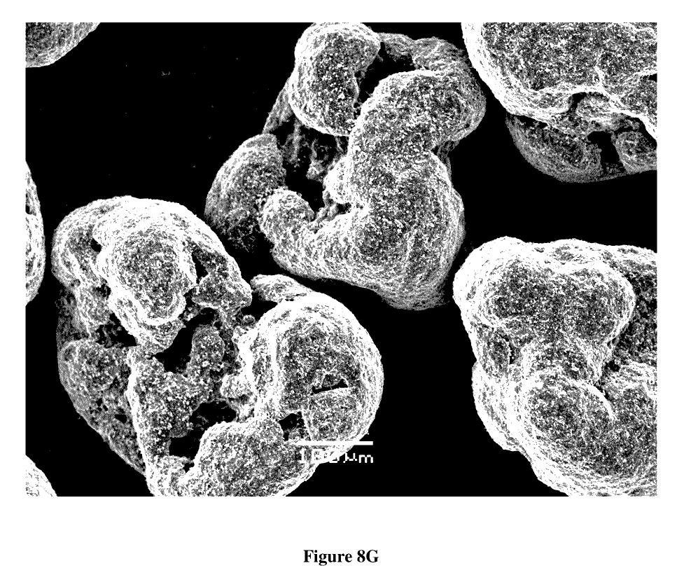

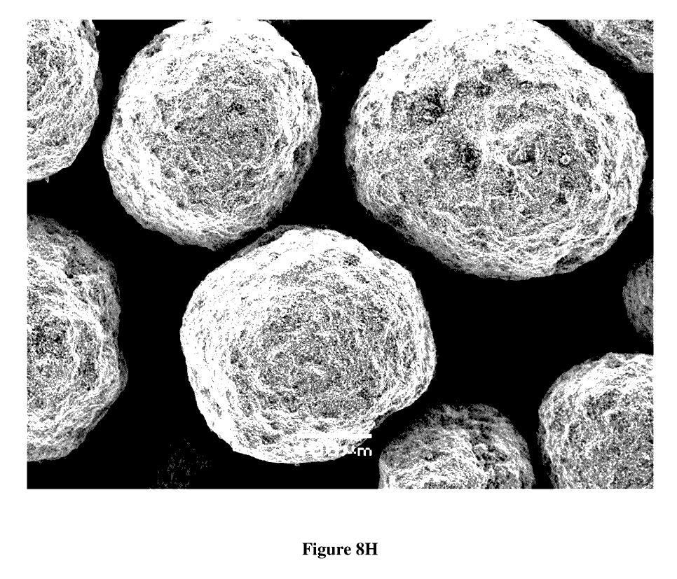

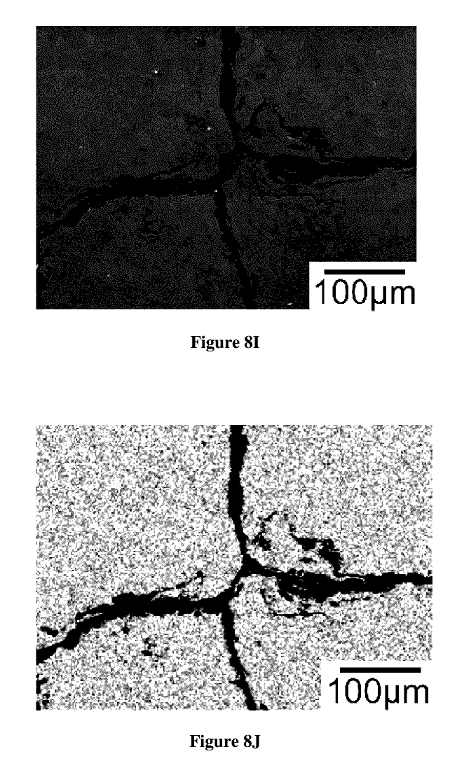

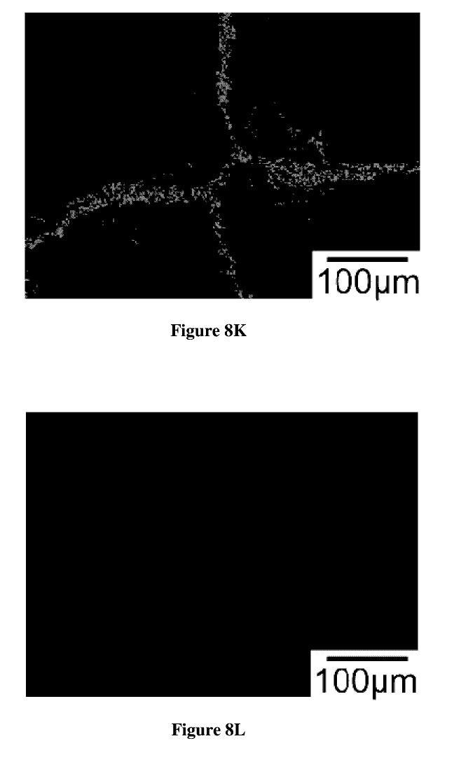

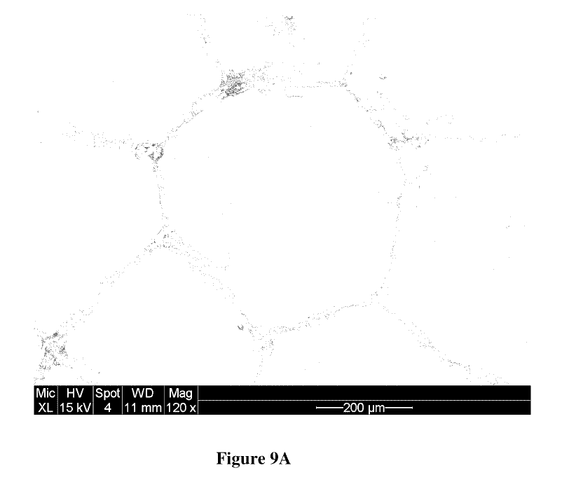

In this example, iron powder was milled with 0.5 to 3 mm alumina media balls in an alumina vial for time ranging from 2 to 24 hours in air. No oxide material was added. Powders were then compacted at 725 ksi pressure and cured at 500° C. or 900° C. Milled iron powder were characterized using x-ray diffraction (XRD) for analysis of internal defects and morphology. FIG. 8A shows the XRD peaks for powders with mill times ranging from 0 to 24 hours with 2 mm media balls. FIG. 8B shows XRD analysis for powders milled for four hours with media ball sizes ranging from 0.5 to 1 mm.

Magnetization results from vibrating sample magnetometry (VSM) measurements for powders milled from 2 to 24 hours and then compacted and cured at 500° C. or 900° C., are shown in FIG. 8C. Magnetization decreases as mill time increases. This is a strong indication of more internal defects such as dislocations, which hinder magnetic domain wall movement, being present in the longer mill time samples. Powder compacts that are cured at a higher temperature also have lower magnetization results due to potential of having more metal-on-metal contacts resulting from curing step.

FIGS. 8D-8F show SEM images for powders milled in alumina with 2 mm alumina media for 2 hours, 8 hours, and 24 hours, respectively. These images show that as mill time increases, more spherical powders are produced with less external air gaps being present. FIGS. 8G and 8H show SEM images of a powders milled in alumina for four hours with 0.5 mm and 3 mm media balls, respectively. FIG. 8I shows an SEM image of a contact point of four individual powders in a compact from powder milled for 4 hours with 2 mm alumina in an alumina vial, compacted then cured at 500° C. FIGS. 8J-8L show EDS scans of FIG. 8I, which exemplifies powders being individually coated with aluminum and oxygen, therefore most likely alumina FIG. 8J represents iron, FIG. 8K represents oxygen, and FIG. 8L represents aluminum.

### Example 7

In this example, 4 g of coarse Fe powder and 8 g of 2 mm hardened steel balls were milled in a hardened steel vial for 2 hours. The media balls were removed, followed by adding 40 mg of bulk Fe₃O₄ and milling for an additional hour. The resultant mixture was compacted. The compacts were cured at 500° C. and 900° C. for one hour.

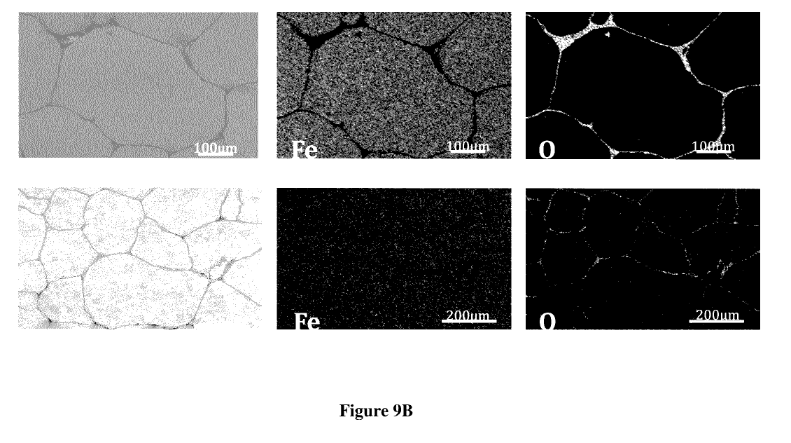

FIG. 9A shows an SEM image of an annealed compact. FIG. 9B shows SEM and EDS images of a compact cured for 500° C. in the top row of images, and a compact cured at 900° C. in the bottom row of images. As seen, a compact cured at 900° C. does not maintain the insulating coating of individual powders, leading to extensive amounts of metal-to-metal contact points. Therefore, more iron oxide particles are needed in order to maintain a sufficient amount of coating.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meanings of the terms in which the appended claims are expressed.

1. A soft magnetic composite comprising:
a ferromagnetic material selected from the group consisting of iron and iron alloys; and
an oxide,
wherein the ferromagnetic material is coated by the oxide, and an interface between the ferromagnetic material and the oxide contains antiphase domain boundaries.

2. The soft magnetic composite of claim 1, wherein the iron alloy is selected from the group consisting of iron-silicon alloy, iron-aluminum alloy, iron-silicon-aluminum alloy, ion-nickel alloy, iron-cobalt alloy, iron-cobalt-nickel alloy, and combinations thereof.

3. The soft magnetic composite of claim 1, wherein the oxide is selected from the group consisting of MgO, Fe₃O₄, NiFe₂O₄, MnFe₂O₄, CoFe₂O₄, CuFe₂O₄, CoZnOFe₂O₃, MnZnOFe₂O₃, and NiZnOFe₂O₃.

4. The soft magnetic composite of claim 1, wherein the layer of oxide has a thickness from about 10 nm to about 5 μm.

5. The soft magnetic composite of claim 1, wherein a surface of the ferromagnetic material has a layer of Fe₂O₃.

6. The soft magnetic composite of claim 5, wherein the layer of Fe₂O₃ has a thickness in a range of from about 1 nm and about 5 nm.

7. A process for producing a soft magnetic composite, said process comprising steps of:
depositing an oxide layer onto a ferromagnetic material core selected from the group consisting of iron and iron alloys by molecular beam epitaxy at a partial oxygen pressure of from about 1×10⁻⁵ Torr to about 1×10⁻⁷ Torr to form coating particles and compacting the coated particles to form a composite.

8. The process of claim 7, wherein the iron alloys is selected from the group consisting of iron-silicon alloy, iron-aluminum alloy, iron-silicon-aluminum alloy, ion-nickel alloy, iron-cobalt alloy, iron-cobalt-nickel alloy, or combinations thereof.

9. The process of claim 7, wherein the oxide is selected from the group consisting of MgO, Fe₃O₄, NiFe₂O₄, MnFe₂O₄, CoFe₂O₄, CuFe₂O₄, CoZnOFe₂O₃, MnZnOFe₂O₃, and NiZnOFe₂O₃.

10. The process of claim 7, wherein partial oxygen pressure is in a range of from about 5×10⁻⁶ Torr to about 5×10⁻⁷ Torr.

11. The process of claim 7, wherein the oxide layer has a thickness of from about 10 nm to about 5 μm.

12. The process of claim 7, further comprising the step of annealing the composite at a temperature from about 250 to about 1200° C.

13. The process of claim 12, wherein the annealing step is conducted for a period from about 15 minutes to about 4 hours.

14. A soft magnetic composite produced by the process of claim 7.

15. A process for producing soft magnetic composite, said process comprising steps of:
milling a ferromagnetic material powder selected from iron powder and an iron ally powder and an oxide powder to form ferromagnetic particles coated with oxide;
compacting the ferromagnetic particles coated with oxide to form a compact; and
annealing the compact at a temperature from about 400 to about 1200° C. to form a soft magnetic composite.

16. The process of claim 15, wherein the ferromagnetic material powders have a particle size from about 10 to about 1000 μm.

17. The process of claim 15, wherein the oxide powders have a particle size from about 10 nm to about 50 μm.

18. The process of claim 15, wherein the ferromagnetic material powder has a particle size in a range of from about 150 μm to about 420 μm, and the oxide powder has a particle size in a range of from about 50 nm to about 100 nm.

19. The process of claim 15, wherein a ratio of ferromagnetic material powder particle size to oxide powder particle size is from about 5 to about 40000.

20. The process of claim 15, wherein the milling step includes at least one polymeric resin selected from the group consisting of thermoplastic resins, thermosetting resins, combinations thereof.

21-30. (canceled)
